(19) United States
(12) Patent Application Publication
(10) Pub. No.: US 2010/0047431 A1
(43) Pub. Date: Feb. 25, 2010

(54) Bagel product and process for producing a bagel product

(76) Inventor: Gregory Toufayan, Upper Saddle River, NJ (US)

Correspondence Address: LUCAS & MERCANTI, LLP, 475 PARK AVENUE SOUTH, 15TH FLOOR, NEW YORK, NY, 10016, US

(21) Appl. No.: 12/290,144

(22) Filed: Oct. 28, 2008

Related U.S. Application Data
(60) Provisional application No. 61/189,515, filed on Aug. 20, 2008.

(51) Int. Cl. A21D 13/00; A21D 6/00

(52) U.S. Cl. 426/653; 426/502

(57) ABSTRACT

A method for making a hollow bagel product, including the steps of providing dough, sheeting the dough to a desired thickness, stamping ring-shaped pieces from the dough to form a stream of dough pieces, proofing the ring-shaped dough pieces and baking the proofed ring-shaped dough pieces in a conveyorized tunnel even at a temperature and for a time sufficient to cause the dough to blister between an outside diameter and an inside diameter of each ring-shaped section so as to form a hollow bagel.

This application claims the benefit of Provisional Application 61/189,515 filed Aug. 20, 2008.

### BACKGROUND OF THE INVENTION

The present invention relates to bagels, and more particularly to a method for preparing a high volume of hollow bagels.

Bagels are very well known products. Bagels are either hand made, typically the types bought at a local bagel shop, or machine made, typically the type bought frozen at a grocery store. The average bagel is very doughy and contains a large number of carbohydrates. In today's weight conscious society it has become common for customers at bagel shops to request that the inside of the bagel be “scooped out” before the bagel is used to make a sandwich or a spread is put on the bagel. Although this is normally done by hand, there have been devices invented to accomplish this “scooping out”, see for example U.S. Pat. No. 4,979,419 to Sonkin.

In response to this demand in the market place, a number of bagel shops produce what is commonly known as a “flagel”. A flagel is basically a bagel with less internal dough after it is baked so that the end product has a relatively flat appearance. The problem with a flagel is that it is not hollow. Therefore, when a spread, such as cream cheese, is used on the flagel it can tend to squeeze out the sides of the flagel when eaten.

At present, to applicant's knowledge, there is no process available for automating the production of bagels whereby an essentially hollow bagel product can be produced quickly and in large numbers.

### SUMMARY AND DESCRIPTION OF THE INVENTION

The process starts by measuring ingredients and mixing them together to produce dough. This can be accomplished in several different ways depending on the desired batch size and the personal preference of the baker.

Next, the dough passes through a “sheeting” system that reduces the dough to a continuous sheet of a desired thickness. Sheeting is a process of rolling and stretching a mass of dough. The sheeting reduces the thickness of the dough to approximately 0.5 inches.

Ring shaped pieces of dough are then stamped out from the dough sheet. This can be accomplished in a single step or in two steps, i.e. first a round piece is stamped and then a hole is stamped in the middle of the round piece. Excess parts, scrap or webbing of the dough which is left over after the stamping is stripped or pulled back from the stream of formed dough pieces to be recycled into future batches of dough to be processed. The stamping produces a dough piece with an outer diameter of approximately 4 inches and an inner diameter of approximately 0.75 inches.

The formed, flat ring-shaped dough pieces are next proofed in a proofing machine such as a typical proofing conveyor system used in the production of pita bread. Here the dough travels down a series of conveyor belts contained in a box or room while being temperature and humidity controlled. At the end of each conveyor belt, the dough is flipped over and proceeds downward in a cascading motion onto another belt a few inches below the previous belt traveling in the opposite direction. The number of belts that the dough pieces travel down depends on the desired proofing time. The dough pieces continue to go back and forth dropping down a level at the end of each conveyor belt until they reach the end of the lowest or last conveyor belt. At this point the dough pieces are transferred to another conveyor belt moving out of the proofing box or room.

As is known, proofing is when dough is left alone, usually in a controlled atmosphere that is warm and humid to allow for fermentation to take place. This creates gas in the dough which causes the dough piece to grow in size, often referred to as “rising”.

After proofing, the dough pieces travel on a conveyor belt to a conveyorized hot water bath boiler. This step provides the bagel product with a tough/hard shiny crust because the dough pieces are cooked for a short time in the boiling bath of water. This step can optionally be left out or bypassed, which would result in a final bagel product that has a different texture and flavor then a traditional bagel.

Next, the boiled (or unboiled) dough pieces travel from the proofer or boiler into a conveyorized tunnel oven. The oven bakes the dough pieces at a very high temperature and for a short period of time. Pursuant to the present invention, the dough pieces are baked at approximately 750°-1000° F. for a period of 0.75-1.5 minutes. Due to the high heat of the oven and the thinness of the dough piece entering the oven, the dough of the bagel product blisters between the outer diameter and the inner diameter to form a pocket.

The bread is then cooled in a conventional manner on a conveyorized cooling belt either at ambient or controlled temperatures with or without fans depending on the current ambient temperatures in the bakery as well as the weather conditions outside and other factors.

After being cooled, the bagel product is sliced to create a top half and a bottom half which remain together and are packaged for delivery to the retailer.

When the sliced bagel product is opened it will have an appearance similar to a conventional bagel which has been sliced in half and then been “scooped out”. This “scooped out” void is a convenient space for spreads or sandwich filings, without having to manually scoop out the bagel.

Although the present invention has been described in relation to particular embodiments thereof, many other variations and modifications and other uses will become apparent to those skilled in the art. It is preferred, therefore, that the present invention be limited but by the specific disclosure herein, but only by the appended claims.

1. A method for making hollow bagel products, comprising the steps of:
providing dough;
sheeting the dough to a desired thickness;
stamping ring-shaped pieces from the dough to form a stream of dough pieces;
proofing the ring-shaped dough pieces;
baking the proofed ring-shaped dough pieces in a conveyorized tunnel even at a temperature and for a time sufficient to cause the dough to blister between an outside diameter and an inside diameter of each ring-shaped section so as to form a hollow bagel.

2. The method according to claim 1, wherein the step of providing dough includes measuring and mixing ingredients to make the dough.

3. The method according to claim 1, further including pulling back scrap pieces of dough from the stream of ring-shaped dough pieces.

4. The method according to claim 1, wherein the sheeting step includes sheeting the dough to a thickness of about 0.5 inches.

5. The method according to claim 1, wherein the stamping step includes stamping ring-shaped pieces of dough having an outer diameter of about 4 inches and an inner diameter of about 0.75 inches.

6. The method according to claim 1, wherein the proofing step includes proofing the ring-shaped dough pieces in a conveyor proofing system.

7. The method according to claim 1, and further comprising the step of boiling the ring-shaped dough pieces after the proofing step.

8. The method according to claim 7, wherein the boiling step includes boiling the ring-shaped dough pieces in a conveyorized hot water bath boiler.

9. The method according to claim 1, wherein the baking step includes baking the ring-shaped dough pieces at about 750°-1000° F. for 0.75 to 1.5 minutes.

10. The method according to claim 8, wherein the baking step includes baking the ring-shaped dough pieces at about 750°-1000° F. for 0.75 to 1.5 minutes.

11. The method according to claim 1, and further comprising the step of cooling the dough pieces after baking.

12. The method according to claim 11, and further comprising the step of slicing the bagels after cooling.

13. The method according to claim 12, further comprising the step of packaging the sliced bagels.

14. A hollow bagel product made by:
providing dough;
sheeting the dough to a desired thickness;
stamping ring-shaped pieces from the dough to form a stream of dough pieces;
proofing the ring-shaped dough pieces;
baking the proofed ring-shaped dough pieces in a conveyorized tunnel even at a temperature and for a time sufficient to cause the dough to blister between an outside diameter and an inside diameter of each ring-shaped section so as to form a hollow bagel.

15. The method according to claim 14 wherein the sheeting step includes sheeting the dough to a thickness of about 0.5 inches.

16. The method according to claim 14, wherein the stamping step includes stamping ring-shaped pieces of dough having an outer diameter of about 4 inches and an inner diameter of about 0.75 inches.

17. The method according to claim 14, wherein the proofing step includes proofing the ring-shaped dough pieces in a conveyor proofing system.

18. The method according to claim 14, and further comprising the step of boiling the ring-shaped dough pieces after the proofing step.

19. The method according to claim 18, wherein the boiling step includes boiling the ring-shaped dough pieces in a conveyorized hot water bath boiler.

20. The method according to claim 19, wherein the baking step includes baking the ring-shaped dough pieces at about 750°-1000° F. for 0.75 to 1.5 minutes.

21. The method according to claim 14, and further comprising the step of cooling the dough pieces after baking.

22. The method according to claim 14, and further comprising the step of slicing the bagels after cooling.
